(19) United States
(12) Patent Application Publication
(10) Pub. No.: US 2018/0004573 A1
(43) Pub. Date: Jan. 4, 2018

(54) LOCKLESS MEASUREMENT OF EXECUTION TIME OF CONCURRENTLY EXECUTED SEQUENCES OF COMPUTER PROGRAM INSTRUCTIONS

(71) Applicant: Microsoft Technology Licensing, LLC, Redmond, WA (US)

(72) Inventors: Marcus Markiewicz, Mercer Island, WA (US); Nicolas Borden, Seattle, WA (US); Michal Piaseczny, Redmond, WA (US)

(21) Appl. No.: 15/197,671

(22) Filed: Jun. 29, 2016

(51) Int. Cl. G06F 9/50; G06F 3/06; G06F 9/52

(52) U.S. Cl. CPC G06F 9/5016; G06F 9/52; G06F 3/0673; G06F 3/061; G06F 3/0656; G06F 3/0631; G06F 3/0659

(57) ABSTRACT

A computer system supports measuring execution time of concurrent threads. A thread allocates a timing buffer in thread local storage. During execution, the thread also has access to a system timer which it can sample with microsecond or better precision with a single instruction. For any sequence of instructions within the thread for which execution time is to be measured, the sequence of instructions has an identifier and includes two commands, herein called a start command and an end command. The start command samples the system timer to obtain a start time, and stores the identifier and the start time in the timing buffer in the thread local storage. The end command samples the system timer to obtain an end time, and updates the data for the corresponding identifier in the timing buffer, to indicate an elapsed time for execution of the sequence of instructions. The start command and end command each can be implemented as a single executable instruction.

### BACKGROUND

In a high performance computer system, such as a real time control system, precise measurement of execution time of any individual operation or set of operations in a computer program is important for identifying potential areas for improvement. However, measuring performance of a computer system can affect the performance of the computer system. Ideally, any technique to measure execution time in a high performance computer system should maintain and not adversely impact any performance guarantees of the computer system, such as real time performance, while providing microsecond precision and utilizing minimal memory resources.

Such constraints on measuring execution time in a high performance computer system are particularly challenging if the computer system supports concurrent operations by different independent portions of a computer program or by different computer programs. These challenges are exacerbated if use of the computer system is outside the control of the developer of the computer system, such as with a consumer device. In such use, different computer systems have different resources, applications, versions, updates, usage patterns, and so on.

### SUMMARY

This Summary is provided to introduce a selection of concepts in a simplified form that are further described below in the Detailed Description. This Summary is intended neither to identify key or essential features, nor to limit the scope, of the claimed subject matter.

A computer system supports measuring execution time of concurrent operations by different independent portions of a computer program or by different computer programs. An independent portion of a computer program, herein called a thread, includes thread local storage accessible only to that thread during execution of the thread by its processor. During execution, the thread also has access to a high performance system timer, which drives the timing of the processor, to allow sampling of the system timer with microsecond or better precision with a single instruction. The thread allocates a timing buffer in the thread local storage.

For any sequence of instructions within the thread for which execution time is to be measured, the sequence of instructions has an identifier and includes two commands, herein called a start command and an end command. The start command is an instruction at the beginning of the sequence of instructions to be measured; the end command is an instruction at the end of the sequence of instructions to be measured. The start command samples the system timer to obtain a start time, and stores the identifier and the start time in the timing buffer in the thread local storage. The end command samples the system timer to obtain an end time, and updates the data for the corresponding identifier in the timing buffer, to indicate an elapsed time for execution of the sequence of instructions. The elapsed time can be so indicated, for example, by storing the start time and the end time, or by computing and storing the difference between the start time and the end time. The start command and end command each can be implemented as a single executable instruction.

With a computer system that can execute multiple concurrent threads, execution time for sequences of instructions in concurrent threads can measured using these techniques in a lock-less fashion, because each thread accesses its own thread local storage to store timing data. Further, the execution time can be measured with microsecond, or better, precision, because the system timer is sampled just at the beginning and end of execution of the sequence of instructions for which execution time is being measured. Additionally, execution time can be measured with minimal impact on performance, by using single executable instructions to capture start times and end times and by using a relatively small timing buffer in thread local storage.

The data in the timing buffers for multiple threads can be collected and stored by the computer program for later analysis. For example, in response to termination of execution of a thread, or the computer program including the thread, or in response to some other event, the timing buffers allocated by the computer program can be collected and stored by, for example, the computer program or by the operating system.

Using such techniques, any computer program also can be written to allow execution time to be measured for any sequence of instructions in a thread of the computer program. In one implementation, source code of the computer program can be annotated with keywords indicating a start point of a sequence of instructions for which execution time is to be measured, and an end point of that sequence of instructions. A compiler or pre-compiler can process such keywords so as to assign identifiers to the corresponding sequences of instructions, and to insert corresponding instructions (implementing the start command and the end command) in the computer program.

In the following description, reference is made to the accompanying drawings which form a part hereof, and in which are shown, by way of illustration, specific example implementations. Other implementations may be made without departing from the scope of the disclosure.

### BRIEF DESCRIPTION OF THE DRAWINGS

FIG. 1 is a block diagram of an example computer.

FIG. 2 is an illustrative diagram of execution of multiple concurrent threads.

FIG. 3 is an illustrative example of instructions including a start command and an end command.

FIG. 4 is a flow chart describing an example implementation of executing a computer program that measures execution time of a sequence of instructions.

FIG. 5 is an illustrative example of pseudo-source code with tags indicating a sequence of instructions.

FIG. 6 is a flow chart describing an example implementation of processing source code.

### DETAILED DESCRIPTION

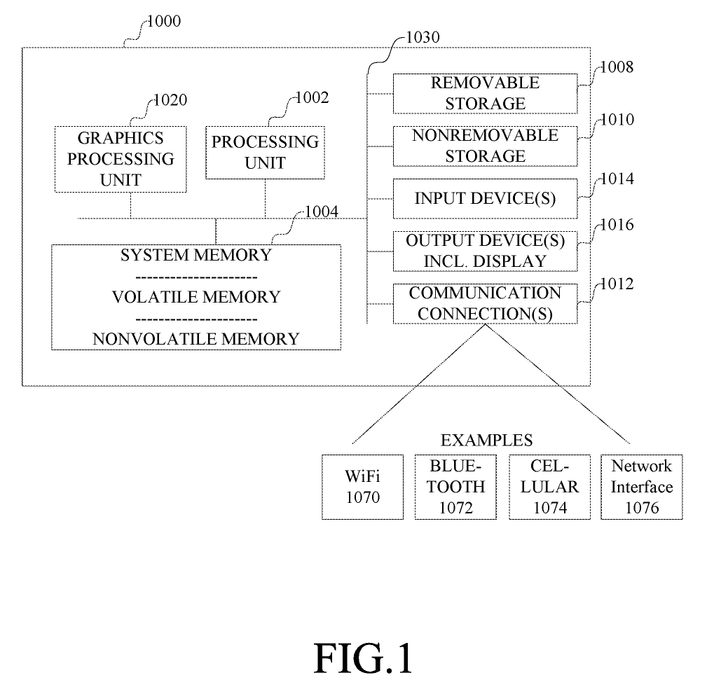

FIG. 1 illustrates an example of a computer with which techniques described herein can be implemented. This is only one example of a computer and is not intended to suggest any limitation as to the scope of use or functionality of such a computer.

The computer can be any of a variety of general purpose or special purpose computing hardware configurations. Some examples of types of computers that can be used include, but are not limited to, personal computers, game consoles, set top boxes, hand-held or laptop devices (for example, media players, notebook computers, tablet computers, cellular phones including but not limited to “smart” phones, personal data assistants, voice recorders), server computers, multiprocessor systems, microprocessor-based systems, programmable consumer electronics, networked personal computers, minicomputers, mainframe computers, and distributed computing environments that include any of the above types of computers or devices, and the like.

With reference to FIG. 1, a computer 1000 includes a processing system comprising at least one processing unit 1002 and memory 1004. The computer can have multiple processing units 1002 and multiple devices implementing the memory 1004. A processing unit 1002 comprises a processor which is logic circuitry which responds to and processes instructions to provide the functions of the computer. A processing unit can include one or more processing cores (not shown) that are processors within the same logic circuitry that can operate independently of each other. Generally, one of the processing units in the computer is designated as a primary processing unit, typically called the central processing unit (CPU). Additional co-processing units, such as a graphics processing unit (GPU), also can be present in the computer. A co-processing unit comprises a processor that performs operations that supplement the central processing unit, such as but not limited to graphics operations and signal processing operations. Execution of instructions by the processing units is generally controlled by one or more system timers, which are generally derived from a system clock. A clock is a signal with a frequency; a timer provides a time as an output value that increments or decrements according to the frequency of the clock signal.

The memory 1004 may include volatile computer storage devices (such as dynamic random access memory (DRAM) or other random access memory device), and non-volatile computer storage devices (such as a read-only memory, flash memory, and the like) or some combination of the two. A nonvolatile computer storage device is a computer storage device whose contents are not lost when power is removed. Other computer storage devices, such as dedicated memory or registers, also can be present in the one or more processors. The computer 1000 can include additional computer storage devices (whether removable or non-removable) such as, but not limited to, magnetically-recorded or optically-recorded disks or tape. Such additional computer storage devices are illustrated in FIG. 1 by removable storage device 1008 and non-removable storage device 1010. Such computer storage devices 1008 and 1010 typically are nonvolatile storage devices. The various components in FIG. 1 are generally interconnected by an interconnection mechanism, such as one or more buses 1030.

A computer storage device is any device in which data can be stored in and retrieved from addressable physical storage locations by the computer. A computer storage device thus can be a volatile or nonvolatile memory, or a removable or non-removable storage device. Memory 1004, removable storage 1008 and non-removable storage 1010 are all examples of computer storage devices. Some examples of computer storage devices are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage devices and communication media are mutually exclusive categories of media, and are distinct from the signals propagating over communication media.

Computer 1000 may also include communications connection(s) 1012 that allow the computer to communicate with other devices over a communication medium. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media, such as metal or other electrically conductive wire that propagates electrical signals or optical fibers that propagate optical signals, and wireless media, such as any non-wired communication media that allows propagation of signals, such as acoustic, electromagnetic, electrical, optical, infrared, radio frequency and other signals.

Communications connections 1012 are devices, such as a wired network interface, wireless network interface, radio frequency transceiver, e.g., WiFi 1070, cellular 1074, long term evolution (LTE) or Bluetooth 1072, etc., transceivers, navigation transceivers, e.g., global positioning system (GPS) or Global Navigation Satellite System (GLONASS), etc., network interface devices 1076, e.g., Ethernet, etc., or other device, that interface with communication media to transmit data over and receive data from the communication media.

The computer 1000 may have various input device(s) 1014 such as a pointer device, keyboard, touch-based input device, pen, camera, microphone, sensors, such as accelerometers, thermometers, light sensors and the like, and so on. The computer 1000 may have various output device(s) 1016 such as a display, speakers, and so on. Such devices are well known in the art and need not be discussed at length here. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface, as well as technologies for sensing brain activity using electric field sensing electrodes (EEG and related methods).

The various computer storage devices 1008 and 1010, communication connections 1012, output devices 1016 and input devices 1014 can be integrated within a housing with the rest of the computer, or can be connected through various input/output interface devices on the computer, in which case the reference numbers 1008, 1010, 1012, 1014 and 1016 can indicate either the interface for connection to a device or the device itself as the case may be.

A computer generally includes an operating system, which is a computer program that manages access, by applications running on the computer, to the various resources of the computer. There may be multiple applications. The various resources include the memory, storage, input devices and output devices, such as display devices and input devices as shown in FIG. 1. To manage access to data stored in nonvolatile computer storage devices, the computer also generally includes a file system maintains files of data. A file is a named logical construct which is defined and implemented by the file system to map a name and a sequence of logical records of data to the addressable physical locations on the computer storage device. Thus, the tile system hides the physical locations of data from applications running on the computer, allowing applications access data in a file using the name of the file and commands defined by the file system. A file system provides basic tile operations such as creating a file, opening a file, writing a file, reading a file and closing a file.

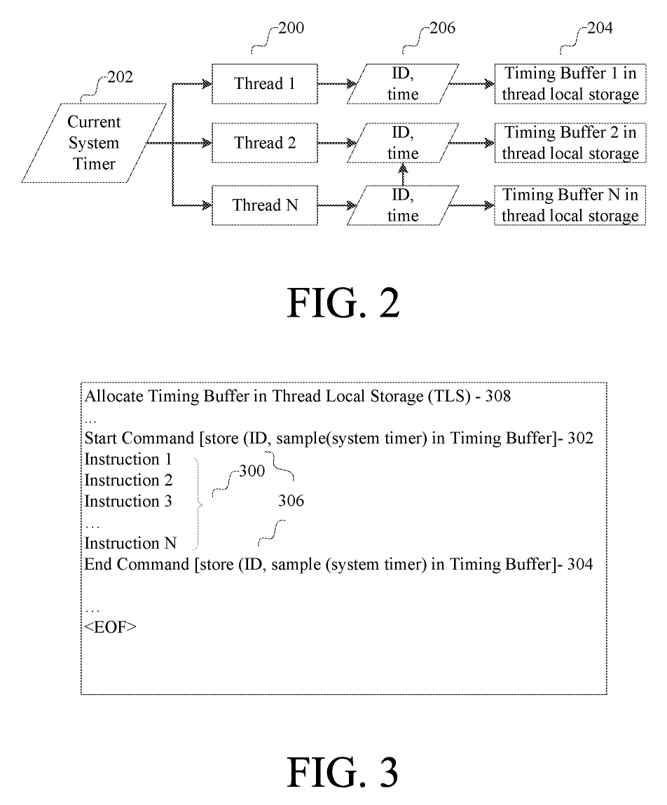

The various modules, tools, or applications, and data structures and flowcharts of FIGS. 2 through 6, as well as any operating system, file system and applications on a computer in FIG. 1, can be implemented using one or more processing units of one or more computers with one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct or configure the computer to perform operations on data, or configure the computer to implement various components, modules or data structures.

Alternatively, or in addition, the functionality of one or more of the various components described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Given such a computer as shown in FIG. 1, the computer may include a processing unit that allows for concurrent execution of different independent portions of a computer program or by different computer programs. Such concurrent execution can be supported by execution on different cores of the same processing unit, by execution on different processing units in a multiprocessor system, and/or by execution of processing on different processors such as a central processing unit and a graphics processing unit.

For simplicity herein, an independent portion of a computer program is herein called a thread. In the examples below, example operation of the system is described in the context of concurrent execution of two threads. In these examples, the two threads can be two different independent portions of a computer program, two different instances of the same independent portion of a computer program, or two independent portions of two different computer programs. Further, in practice, the term thread may be used differently with respect to different operating systems and/or computers. Thus, the term “thread” herein is intended to mean a sequence of programmed instructions that can be managed independently by an operating system and for which thread local storage can be allocated in memory in a manner accessible only to that thread during execution of the thread. Such thread local storage generally can be allocated by an application program through an application programming interface provided by the operating system or through constructs provided by a programming language.

Accordingly, turning to FIG. 2, a positive integer number N of concurrent threads 200 are illustrated. During execution, each thread 200 also has access to a high performance system timer 202 that drives the timing of the processor. The thread 200 can sample the system timer 202 with microsecond or better precision with a single instruction. The thread allocates a timing buffer 204 in the thread local storage, in which timing data 206, such as an identifier of a sequence of instructions and a time, for the thread is stored.

Turning now to FIG. 3, for any sequence of instructions within the thread for which performance time is to be measured, such as shown at 300, the sequence of instructions has an identifier 306 and includes two commands, herein called a start command 302 and an end command 304. The start command is an instruction at the beginning of the sequence of instructions to be measured; the end command is an instruction at the end of the sequence of instructions to be measured. The start command samples the system timer to obtain a start time, and stores the identifier 306 and the start time in the timing buffer in the thread local storage. The end command samples the system timer to obtain an end time, and updates the data for the corresponding identifier 306 in the timing buffer, to indicate an elapsed time for execution of the sequence of instructions. The elapsed time can be so indicated, for example, by storing the start time and the end time, or by computing and storing the difference between the start time and the end time. The start command and end command each can be implemented as a single executable instruction.

FIG. 3 provides illustrative pseudo-code of a sequence of instructions 300 having a start command 302 and an end command 304. There can be multiple such sequences 300 of instructions, with different identifiers 306, within any given thread. The thread also can include instructions 308 that, when executed, the thread allocates a timing buffer in thread local storage (TLS).

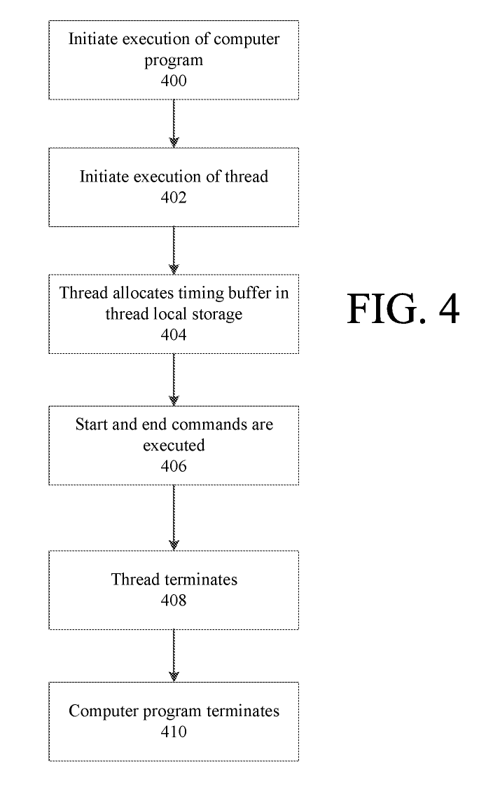

Turning now to FIG. 4, a flow chart of an example implementation of executing a computer program with a thread for which execution time is measured will now be described.

This example illustrates how a computer program operates when it includes a thread for which execution time for a sequence of instructions is measured. While the illustration includes discussion of a single thread and a single sequence of instructions, it should be understood that the thread can include multiple different sequences of instructions for which execution time can be measured. Such a computer program can include multiple threads that execute concurrently, each of which can include one or more sequences of instructions for which execution time can be measured. It should be understood that multiple computer programs can execute concurrently as well, each of which having one or more threads including one or more sequences of instructions for which execution time is measured.

As shown in FIG. 4, execution of the computer program is initiated 400. At some point in time during execution of the computer program, execution of a thread of the computer program is initiated 402. After initiating execution of the thread, the thread allocates 404 a timing buffer in its thread local storage. As the thread executes, the start command and end command for the sequence of instructions are encountered and executed 406, resulting in corresponding timing data being stored in the timing buffer. At some point, the thread terminates 408 and the computer program terminates 410. Whether during execution of the thread, such as between steps 406 and 408, upon termination of the thread in step 408, during execution the computer program, such as between steps 408 and 410, upon termination of the computer program in step 410, or upon some other specified event, the data in the timing buffer can be collected and analyzed, whether by the thread, the computer program, the operating system or other process executing on the computer.

With such capabilities being provided in a computer system, any computer program also can be written to allow execution time to be measured for any sequence of instructions in a thread of the computer program. In one implementation, a developer can insert, into source code, start commands and end commands for any sequence of instructions with an identifier for which execution time is to be measured.

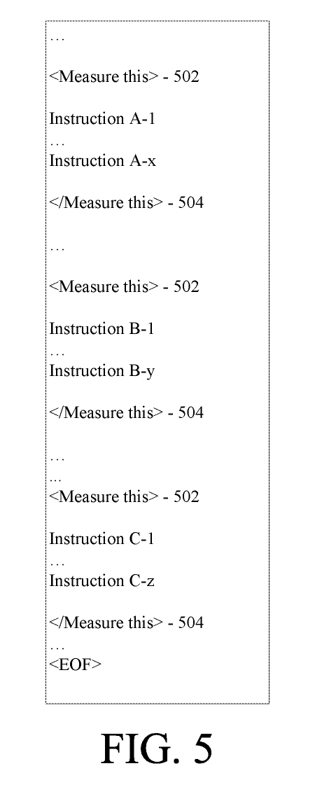

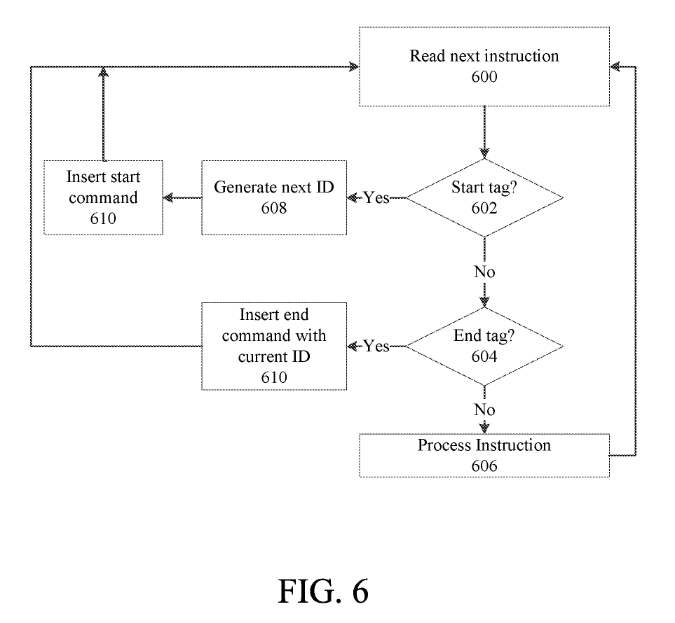

In one implementation, described now in connection with FIGS. 5 and 6, source code of the computer program can be annotated with keywords indicating a start point in a sequence of instructions to be measured, and an end point in the sequence of instructions to be measured. A compiler or pre-compiler can process such keywords so as to assign identifiers to the corresponding sequences of instructions, and to insert corresponding instructions (implementing the start command and the end command) in the computer program.

FIG. 5 shows an illustrative example of pseudo-source code for which execution time of sequences of instructions is to be measured. The code in FIG. 5 includes three sequences of instruction labeled A, B and C. Sequence A includes a number x of instructions; Sequence B includes a number y of instructions; Sequence C includes a number z of instructions. It should be understood that x, y and z can be arbitrary numbers of instructions and that the operations performed by these sequences of instructions can be arbitrary. However, it should be understood that a developer would likely only mark sequences of instructions for which the execution time to be measured has some significance.

The sequences of instructions are delimited by one or more tags, e.g., in this example for purposes of illustration only, a “<Measure this>” tag (502) to mark the start of the sequence of instructions and a “</Measure this>” tag (504) to mark the end of the sequence of instructions. In this example for purposes of illustration only, the tags are illustrated in the form of a markup tag such as an XML tag. The choice of form and content of the tag can be arbitrary so long as the tag is not a reserved keyword or symbol in the computer programming language used for the source code and is otherwise unique. Different start and end tags can be used, or a single tag can be used to designate both start and end, with context being used to differentiate a start from an end. Tags can have syntax such that they can include additional data.

Given source code that includes such tags, the source code can be processed, for example by a pre-compiler or compiler, to identify the tags, and thus the sequences of instructions for which execution time is to be measured. Each sequence of instructions so identified can be assigned a unique identifier through such processing. Thus, a developer of the source code can simply mark the sequences of instructions with the keyword and not be concerned with assigned unique identifiers to the sequences of instructions. Using a pre-compiler implementation, source code instructions can be inserted in the source code in place of the tags to as to provide the start command and end command for capturing execution time data. Using a compiler implementation, such tags can be converted into executable instructions for the start and end commands.

FIG. 6 is a flowchart describing an example implementation of processing source code that is marked such as in FIG. 5. A pre-compiler computer program can be written to implement this process so as to modify source code that has been marked before it is compiled. Such a pre-compiler can be executed at the time source code is checked into a source code management system, at compilation time, or any other time selected by the developer. In general, the process involves identifying all start and end tag pairs, associating each of them with a unique identifier, and replacing each of them with a corresponding start command and end command including its unique identifier. Thus, a next instruction 600 is read from the computer program. If the instruction is neither a start tag , as determined at 602, nor an end tag, as determined at 604, it can be otherwise processed (which can be no processing), as indicated at 606. If the instruction is a start tag, as determined at 602, a next unique identifier is generated 608. For example, the unique identifier can be a number that is initially zero (0) and is incremented as each start tag is encountered. The start command is then inserted 610 into the computer program with this unique identifier, and the next instruction can be read 600. If the instruction is an end tag, as determined at 604, then an end command is inserted into the computer program using the current unique identifier.

With a computer system that can execute multiple concurrent threads, execution time for sequences of instructions in concurrent threads can measured using these techniques in a lock-less fashion, because each thread accesses its own thread local storage to store timing data. Further, the execution time can be measured with microsecond, or better, precision, because the system timer is sampled just at the beginning and end of execution of the sequence of instructions for which timing is being measured. Additionally, execution time can be measured with minimal impact on performance, by using single executable instructions to capture start times and end times and by using a relatively small timing buffer in thread local storage. Using such techniques, any computer program also can be written to allow execution time to be measured for any sequence of instructions in a thread of the computer program.

Accordingly, in one aspect, a computer comprises a processing system comprising a processing unit and a memory and having a system timer. The processing system, for a first thread to be executed by the processing system, allocates a first buffer in first thread local storage in the memory. For a second thread to be executed concurrently by the processing system, and different from the first thread, the processing system allocates a second buffer separate from the first buffer and in second thread local storage in the memory. In response to execution of a first start command at a beginning of a first sequence of instructions for the first thread, the processing system stores, in the first buffer, an identifier of the first sequence of instructions and a first start time from the system timer at the time of execution of the first start command. In response to execution of a first end command at an end of the first sequence of instructions for the first thread, the processing system stores, in the first buffer and in association with the identifier of the first sequence of instructions, data indicative of an elapsed time between the first start time stored in the first buffer and a first end time from the system timer at the time of execution of the first end command. In response to execution of a second start command at a beginning of a second sequence of instructions in the second thread, the processing system stores, in the second buffer, an identifier of the second sequence of instructions and a second start time from the system timer at a time of execution of the second start command. In response to execution of a second end command at an end of the second sequence of instructions for the second thread, the processing system stores, in the second buffer and in association with the identifier of the second sequence of instructions, data indicative of an elapsed time between the second start time stored in the second buffer and a second end time from the system timer at the time of execution of the second end command.

In another aspect, a computer-implemented process performed by a computer program executing on a processing system of a computer, the computer comprising a processing system having a system timer and memory accessible by threads executed by the processing system, comprises for a first thread to be executed by the processing system, allocating a first buffer in first thread local storage in the memory. For a second thread to be executed concurrently by the processing system, and different from the first thread, a second buffer is allocated separate from the first buffer and in second thread local storage in the memory. In response to execution of a first start command at a beginning of a first sequence of instructions for the first thread, an identifier of the first sequence of instructions and a first start time from the system timer at the time of execution of the first start command are stored in the first buffer. In response to execution of a first end command at an end of the first sequence of instructions for the first thread, data indicative of an elapsed time between the first start time stored in the first buffer and a first end time from the system timer at the time of execution of the first end command are stored in the first buffer and in association with the identifier of the first sequence of instructions. In response to execution of a second start command at a beginning of a second sequence of instructions in the second thread, an identifier of the second sequence of instructions and a second start time from the system timer at a time of execution of the second start command are stored in the second buffer. In response to execution of a second end command at an end of the second sequence of instructions for the second thread, data indicative of an elapsed time between the second start time stored in the second buffer and a second end time from the system timer at the time of execution of the second end command are stored in the second buffer and in association with the identifier of the second sequence of instructions.

In another aspect, a computer comprises: a means for allocating, for a first thread, a first buffer in first thread local storage in a memory and means for allocating, for a second concurrent thread, a second buffer in second thread local storage in a memory; a means for storing a start time from the system timer in the first buffer in response to execution of a start command at a beginning of the first thread; a means for storing a start time from the system time in the second buffer in response to execution of a start command at a beginning of the second thread; a means for storing, in the first buffer, data indicative of an elapsed time between the first start time stored in the first buffer and a first end time from the system timer at the time of execution of a first end command; a means for storing, in the second buffer, data indicative of an elapsed time between the second start time stored in the second buffer and a second end time from the system timer at the time of execution of a second end command.

In another aspect, a computer includes means for processing source code, the source code comprising marked sequences of instructions, to insert a start command at a beginning of a marked sequence of instructions and an end command at an end of a marked sequence of instructions, such that when executable code derived from the source code is executed, execution of the start command causes an identifier of the sequence of instructions and a start time from the system timer at the time of execution of the start command to be stored in a buffer in thread local storage, and execution of the end command data indicative of an elapsed time between the start time stored in the buffer and an end time from the system timer at the time of execution of the end command are stored in the buffer and in association with the identifier of the sequence of instructions.

In another aspect, a computer-implemented process processes source code, the source code comprising marked sequences of instructions, to insert a start command at a beginning of a marked sequence of instructions and an end command at an end of a marked sequence of instructions, such that when executable code derived from the source code is executed, execution of the start command causes an identifier of the sequence of instructions and a start time from the system timer at the time of execution of the start command to be stored in a buffer in thread local storage, and execution of the end command data indicative of an elapsed time between the start time stored in the buffer and an end time from the system timer at the time of execution of the end command are stored in the buffer and in association with the identifier of the sequence of instructions.

In any of the foregoing aspects, the first thread and second thread can be executed by different processing units. For example, the first thread can be executed by a first processing core of the processing system and the second thread can be executed by a second processing core, different from the first processing core, of the processing system. As another example, the first thread can be executed by a central processing unit and the second thread can be executed by a graphics processing unit.

In any of the foregoing aspects, the first thread and the second thread are different sequences of computer program instructions. For example, the first thread and second thread can be different threads of a same computer program. As another example, the first thread and the second thread can be threads of different computer programs.

In any of the foregoing aspects, the start command samples the system timer and stores the current time with the identifier in the timing buffer in a single executable instruction.

In any of the foregoing aspects, the end command samples the system timer and stores data indicative of an elapsed time in the timing buffer in a single executable instruction.

In another aspect, an article of manufacture includes at least one computer storage device, and computer program instructions stored on the at least one computer storage device. The computer program instructions, when processed by a processing system of a computer, the processing system comprising one or more processing units and memory accessible by threads executed by the processing system, and having a system timer, configures the computer as set forth in any of the foregoing aspects and/or performs a process as set forth in any of the foregoing aspects.

Any of the foregoing aspects may be embodied as a computer system, as any individual component of such a computer system, as a process performed by such a computer system or any individual component of such a computer system, or as an article of manufacture including computer storage in which computer program instructions are stored and which, when processed by one or more computers, configure the one or more computers to provide such a computer system or any individual component of such a computer system.

It should be understood that the subject matter defined in the appended claims is not necessarily limited to the specific implementations described above. The specific implementations described above are disclosed as examples only. What is claimed is:

1. A computer comprising:
a processing system comprising a processing unit and a memory accessible by threads executed by the processing system, and having a system timer, the processing system configured to:
for a first thread to be executed by the processing system, allocate a first buffer in first thread local storage in the memory;
for a second thread to be executed concurrently by the processing system, and different from the first thread, allocating a second buffer separate from the first buffer and in second thread local storage in the memory;
in response to execution of a first start command at a beginning of a first sequence of instructions for the first thread:
sample the system timer at a time of execution of the first start command to provide a first start time; and
store, in the first buffer, an identifier of the first sequence of instructions and the first start time;
in response to execution of a first end command at an end of the first sequence of instructions for the first thread:
sample the system timer at a time of execution of the first end command to provide a first end time; and
store, in the first buffer and in association with the identifier of the first sequence of instructions, data indicative of an elapsed time between the first start time stored in the first buffer and the first end time;
in response to execution of a second start command at a beginning of a second sequence of instructions in the second thread:
sample the system timer at a time of execution of the second start command to provide a second start time; and
store, in the second buffer, an identifier of the second sequence of instructions and the second start time;
in response to execution of a second end command at an end of the second sequence of instructions for the second thread:
sample the system timer at a time of execution of the second end command to provide a second end time; and
store, in the second buffer and in association with the identifier of the second sequence of instructions, data indicative of an elapsed time between the second start time stored in the second buffer and the second end time.

2. The computer of claim 1, wherein the first thread is executed by a first processing core of the processing system and the second thread is executed by a second processing core, different from the first processing core, of the processing system.

3. The computer of claim 1, wherein the first thread is executed by a central processing unit and the second thread is executed by a graphics processing unit.

4. The computer of claim 1, wherein the first thread and the second thread are different threads of a same computer program.

5. The computer of claim 1, wherein the first thread and the second thread are threads of different computer programs.

6. The computer of claim 1, wherein sampling the system timer and storing the first start time with the identifier in the first buffer occurs in a single executable instruction.

7. The computer of claim 1, wherein sampling the system timer and storing the data indicative of the elapsed time in the first buffer occurs in a single executable instruction.

8. An article of manufacture comprising:
a computer storage device,
computer program instructions stored on the computer storage device which, when processed by a computer, configures the computer to be comprising:
a processing system comprising a processing unit and a memory accessible by threads executed by the processing system, and having a system timer, the processing system configured to:
for a first thread to be executed by the processing system, allocate a first buffer in first thread local storage in the memory;
for a second thread to be executed concurrently by the processing system, and different from the first thread, allocating a second buffer separate from the first buffer and in second thread local storage in the memory;
in response to execution of a first start command at a beginning of a first sequence of instructions for the first thread:
sample the system timer at a time of execution of the first start command to provide a first start time; and
store, in the first buffer, an identifier of the first sequence of instructions and the first start time; first start command;
in response to execution of a first end command at an end of the first sequence of instructions for the first thread:
sample the system timer at a time of execution of the first end command to provide a first end time; and
store, in the first buffer and in association with the identifier of the first sequence of instructions, data indicative of an elapsed time between the first start time stored in the first buffer and the first end time;
in response to execution of a second start command at a beginning of a second sequence of instructions in the second thread:
sample the system timer at a time of execution of the second start command to provide a second start time; and
store, in the second buffer, an identifier of the second sequence of instructions and the second start time
in response to execution of a second end command at an end of the second sequence of instructions for the second thread:
sample the system timer at a time of execution of the second end command to provide a second end time; and
store, in the second buffer and in association with the identifier of the second sequence of instructions, data indicative of an elapsed time between the second start time stored in the second buffer and the second end time.

9. The article of manufacture of claim 8, wherein the first thread is executed by a first processing core of the processing system and the second thread is executed by a second processing core, different from the first processing core, of the processing system.

10. The article of manufacture of claim 8, wherein the first thread is executed by a central processing unit and the second thread is executed by a graphics processing unit.

11. The article of manufacture of claim 8, wherein the first thread and the second thread are different threads of a same computer program.

12. The article of manufacture of claim 8 wherein the first thread and the second thread are threads of different computer programs.

13. The article of manufacture of claim 8, wherein sampling the system timer and storing the first start time with the identifier in the first buffer occurs in a single executable instruction.

14. The article of manufacture of claim 8 wherein sampling the system timer and storing the data indicative of an elapsed time in the first buffer occurs in a single executable instruction.

15. A computer-implemented process performed by a computer program executing on a processing system of a computer, the processing system comprising a processing unit and a memory accessible by threads executed by the processing system, and having a system timer, the process comprising:
for a first thread to be executed by the processing system, allocating a first buffer in first thread local storage in the memory;
for a second thread to be executed concurrently by the processing system, and different from the first thread, allocating a second buffer separate from the first buffer and in second thread local storage in the memory;
in response to execution of a first start command at a beginning of a first sequence of instructions for the first thread:
sampling the system timer at a time of execution of the first start command to provide a first start time; and
storing, in the first buffer, an identifier of the first sequence of instructions and the first start time;
in response to execution of a first end command at an end of the first sequence of instructions for the first thread:
sampling the system timer at a time of execution of the first end command to provide a first end time; and
storing, in the first buffer and in association with the identifier of the first sequence of instructions, data indicative of an elapsed time between the first start time stored in the first buffer and the first end time;
in response to execution of a second start command at a beginning of a second sequence of instructions in the second thread:
sampling the system timer at a time of execution of the second start command to provide a second start time; and
storing, in the second buffer, an identifier of the second sequence of instructions and the second start time;
in response to execution of a second end command at an end of the second sequence of instructions for the second thread:
sampling the system timer at a time of execution of the second end command to provide a second end time; and
storing, in the second buffer and in association with the identifier of the second sequence of instructions, data indicative of an elapsed time between the second start time stored in the second buffer and the second end time.

16. The computer-implemented process of claim 15, wherein the first thread is executed by a first processing core of the processing system and the second thread is executed by a second processing core, different from the first processing core, of the processing system.

17. The computer-implemented process of claim 15, wherein the first thread is executed by a central processing unit and the second thread is executed by a graphics processing unit.

18. The computer-implemented process of claim 15, wherein the first thread and the second thread are threads of different computer programs.

19. The computer-implemented process of claim 15, wherein sampling the system timer and storing the first start time with the identifier in the first buffer occurs in a single executable instruction.

20. The computer-implemented process of claim 15, wherein sampling the system timer and storing the data indicative of the elapsed time in the first buffer occurs in a single executable instruction.
